(19) United States
(12) Patent Application Publication
(10) Pub. No.: US 2018/0353972 A1
(43) Pub. Date: Dec. 13, 2018

(54) APPARATUS AND PROCESS FOR SEPARATING THROUGH FOAM

(71) Applicant: Paolo BOZZATO, Morgantown, WV (US)

(72) Inventor: Paolo BOZZATO, Morgantown, WV (US)

(21) Appl. No.: 16/061,064

(22) PCT Filed: Dec. 6, 2016
(86) PCT No.: PCT/IB2016/057374

§ 371 Date: Jun. 11, 2018

(30) Foreign Application Priority Data
Dec. 11, 2015 (IT) 102015000082442

(51) Int. Cl. B03D 1/14; B03D 1/02; B03D 1/08

(52) U.S. Cl. CPC B03D 1/1462; B03D 1/028; B03D 1/16; B03D 1/082; B03D 1/1406

(57) ABSTRACT

An apparatus for foam separation comprises a foam separation cell (12; 112; 212) provided with a treatment chamber (13), inside of which a flow of liquid containing material to be separated can be introduced. The apparatus further comprises one or more devices (21, 27) for introducing and/or generating air bubbles, useful to carry out the foam separation between the hydrophobic material and the hydrophilic material.

### FIELD OF APPLICATION

The present invention relates to an apparatus and a process for foam separation, which can be used for separating substances having different hydrophobicity, e.g. for separating particles, particularly for mineral treatment purposes, e.g. for treating coal, as well as for environmental, recycling and water treatment purposes, in order to attain separation between solids, between solid and liquid, or between liquids.

### BACKGROUND ART

Foam separation machines are known, which are also called foam separation cells, wherein separation between elements can be made to occur by exploiting the hydrophilic or hydrophobic characteristics of specific elements. In the mining industry, such machines are known as flotation cells. Separation cells generally collect a liquid flow containing the substances to be separated, which is also referred to as pulp when it also includes solids, and gas and/or air bubbles are generated and/or injected, which tend to separate the hydrophobic material from the hydrophilic material.

The hydrophobic material adheres to the bubbles and is transported towards the liquid-air interface, thus generating foams that will tend to aggregate and accumulate in the upper part of the cell, while the hydrophilic material will remain in the pulp to be then drained, for example, at the bottom.

Different types of foam separation cells have been developed, the best known and most common ones being the following:
mechanical separation cells;
column-type separation cells, also called separation columns;
pneumatic separation cells;
induced and dissolved air flotation (DAF).

Said separation cells operate in a gravitational field, and the force that causes the separation between foams and pulp is the gravitational force.

Centrifugal cells have also been developed, wherein the force that produces the separation between foams and pulp is a centrifugal force. Centripetal acceleration can be obtained by feeding the material and the pulp tangentially into the cell, or it can be generated, for example, by turning the body of the foam separation cell about an axis of rotation.

Reagents can be added to the pulp in order to promote separation, improve foam stability, increase the hydrophobicity of the materials that need to be recovered, and reduce the hydrophobicity of those materials that must not be present in the foams.

For example, greater foam thicknesses, or tall foams, can be obtained by using a large amount of frother or more persistent frothers. Larger frother quantities can improve the foam separation results, but generally also have some adverse effects on other parts of the plant and on the environment.

A foam separation cell is typically a process unit integrated into a plant, and very often larger frother quantities will reduce the overall efficiency of the system. Environmental constraints may also limit the type and quantity of reagents that can be used for foam separation, and the effluent may have to be completely treated and then recirculated, resulting in higher production costs.

Mechanical foam separation cells generally consist of walls that define a treatment chamber into which the pulp or liquid is fed. The pulp is kept in agitation by an impeller. The motion of the impeller, combined with the stator, transforms the forced air taken in at base of the rotor into small bubbles through the effect of shearing forces.

Foam separation columns are known which include, typically in their lower part, air-bubble generators that introduce bubbles which, as they rise, intercept the hydrophobic substances in the pulp and carry them upwards. Separation columns are generally also provided with a foam washing assembly to improve foam purity, so that a purer product concentrate can generally be obtained.

In centrifugal separation cells, which generally have a circular shape, the pulp with the material to be separated is fed tangentially in order to impart thereto a centrifugal acceleration. Air transformed into tiny bubbles, e.g. through a Venturi tube, is injected into the material and pulp supply duct.

Mechanical cells have shown that they can ensure good results in terms of hydrophobic material recovery, but they can hardly give highly pure foam concentrates.

Separation columns and pneumatic cells produce taller foams than mechanical cells, and the foams can be washed to remove the impurities contained in the liquid between the bubbles to obtain higher purity.

Centrifugal cells have a greater unitary capacity than the other types of foam separation cells, but they are less efficient in terms of separation.

It has been demonstrated that separation selectivity increases with foam height; for this reason, thicker foams in the foam separation cells will give purer products not just because of foam washing, as is the case of the above-mentioned foam separation columns.

One drawback of the separation cells known in the art is that the depth of the foams reduces the stability thereof, which should be understood as the property of the bubbles of not collapsing.

If the bubbles do not collapse, a certain stability and height of the foams can be obtained which will allow them to continuously reach the intended drain, so that the hydrophobic material can be effectively separated and recovered.

It is one object of the present invention to provide an apparatus for foam separation of hydrophobic substances which allows increasing the height of the foams while preventing them from collapsing.

It is another object of the present invention to provide an apparatus for foam separation of particles, which can be used with any type of foam separation cell known in the art to improve the efficiency of the single foam separation cells and of the whole plant.

It is a further object to provide an apparatus which is simple to install on and/or remove from the foam separation cells and which allows for simple and fast maintenance.

It is a further object to set up a process for foam separation of hydrophobic substances which ensures a more effective separation between hydrophobic and hydrophilic materials as well as larger amounts of foams, in particular taller foams than can be obtained by the prior art.

Last but not least, it is yet another object of the invention to provide a method and/or a device for detecting the properties of the foam during a separation process.

With a view to overcome the shortcomings of the prior art and to achieve these and further objects and advantages, the present Applicant has conceived, tested and implemented the present invention.

### DESCRIPTION OF THE INVENTION

The present invention is set out and characterized in the independent claims. Dependent claims disclose other features of the present invention or variations of the principal inventive idea.

In accordance with the above-mentioned objects, an apparatus for foam separation comprises a foam separation cell and at least one modular foam support element which can be associated with said foam separation cell, preferably in a movable and/or removable manner during the separation process.

Advantageously, the apparatus for foam separation comprises a plurality of modular elements mutually associated to define a three-dimensional structure having large containment and support volumes that provide a large additional support surface for the foams.

Said support structure may have a constant or variable section along one or more development directions.

The modular elements may be shaped as sheets, the thickness of which is much smaller than the dimensions that define the surface development, or they may have an elongated shape with one prevalent dimension, e.g. elongated and/or filiform elements, or small-diameter hollow tubes.

The modular elements may have, in a front view, an oval, circular, square, polygonal, regular or irregular shape, or any other possible shape.

The modular elements may have a substantially flat shape, or they may be curved about one or more axes, or be partly flat and partly curved.

The modular elements may have a constant or variable section along a longitudinal or transverse development.

The modular elements may be arranged parallel to the vertical development of the foam separation cell, or they may be oblique, organized in parallel and/or transverse rows, or arranged in a sunburst pattern or in variable-diameter concentric rings.

For example, the modular elements may be mutually aligned, concentric or oblique.

In some embodiments, the modular elements can be combined together in relation to the average size of the bubbles and/or to the size of the material particles to be separated.

The modular elements may be solid, or they may have through holes or slots to allow the foams and/or pulp or liquid to move in a lateral direction. In this manner, the apparatus can still operate even when one or more foam passage volumes have been obstructed by the material contained therein.

In some embodiments, the apparatus comprises a foam support module defined by one or a plurality of mutually associated modular elements.

The foam support module has peripheral surfaces and inner surfaces. The inner surfaces are defined by a plurality of mutually combined modular elements. The outer surfaces may be defined by the same modular elements, or an enclosure may be provided to enclose said modular elements.

In some embodiments, the foam support modules may comprise a dedicated device for air recirculation and introduction and bubble generation for increased total bubble production, resulting in taller foams. In some variant embodiments, which can be combined with other embodiments, the foam support modules can be associated with washing devices, which may be either connected to or distinct from the washing system included, for example, in column-type cells, thus allowing for improved foam washing and rinsing.

The modular elements and/or the foam support modules can be applied to any existing type of foam separation cell. They can also be integrated by design into new machines.

At any rate, preferably, the modular elements and/or the foam support modules can be installed in a movable and/or removable manner also during the separation process, so that they can be moved or removed in order to take foam samples or to carry out maintenance, cleaning or replacement work and the like.

In some embodiments, the modular elements and/or the foam support modules are installed in the upper part of the foam separation cells, and can be partly placed inside the pulp or on top of it. The modular elements and/or the foam support modules may be applied to the edge of a foam separation cell or associated therewith, or suspended with respect to the pulp.

The modular elements and/or the foam support modules can be so arranged as to cover the whole free surface of the interface between the liquid containing the material to be separated and the foams of a foam separation cell, or only a part thereof.

The foams can be collected by overflow from the top of the foam support modules, or through drain channels leading to collection tanks or collectors, or they may be transferred through connection pipes into a subsequent foam support module, and the concentrate may be taken from the last foam support module of the series.

According to a preferred possible embodiment, the invention comprises a device for taking foam samples, so that foam properties can be detected, such as composition, purity and the like.

### BRIEF DESCRIPTION OF THE DRAWINGS

These and other features of the present invention will become apparent in the light of the following description of some exemplary embodiments thereof, in which reference will be made to the annexed drawings, wherein:

FIG. 1 is a schematic sectional front view of an apparatus for foam separation in accordance with some embodiments described herein;

FIG. 2 is a top view of an apparatus in accordance with some embodiments described herein;

FIGS. 3a-3b are schematic views of embodiments of combinations of modular elements in accordance with some embodiments described herein;

FIG. 4 is a schematic perspective view of a foam support module in accordance with some embodiments described herein;

FIGS. 5a-5c are schematic views of some embodiments of the foam support module of FIG. 3;

FIG. 6 is a schematic view of some apparatuses for foam separation in accordance with some embodiments described herein, connected together in series;

FIG. 7 is a schematic sectional front view of a variant of an apparatus for foam separation in accordance with some embodiments described herein;

FIG. 8 is a top view of an apparatus for foam separation in accordance with the variant of FIG. 7;

FIG. 9 is a schematic sectional front view of a further variant of an apparatus for foam separation in accordance with some embodiments described herein.

For a better understanding, the same reference numerals have been used in the drawings, wherever possible, to identify identical common elements. It goes without further saying that elements and features of one embodiment can be conveniently incorporated into other embodiments as well.

### DESCRIPTION OF SOME EMBODIMENTS

Reference will now be made in detail to various embodiments of the invention, one or more examples of which are illustrated in the annexed drawings. Each example is provided in order to illustrate the invention and should not be understood as a limitation thereof. For instance, the features of an embodiment illustrated or described herein can be adopted in or associated with other embodiments in order to produce a further embodiment. It is understood that the present invention includes all such modifications and variations.

In accordance with the present invention, an apparatus 10 for foam separation can be used for separating hydrophobic substances in general, e.g. for mineral treatment purposes, in particular for coal treatment, or for environmental, recycling and water treatment applications, in order to obtain separation between solids and/or between solid and liquid and/or between liquids.

In the embodiments according to the present description, the expression “foam separation” refers to a chemical process falling within the category of those techniques referred to in the industry as “adsorptive bubble separation”. In particular, two examples of “foam separation” processes are the “froth flotation” process and the “foam fractionation” process.

The apparatus 10 according to the present invention comprises a foam separation cell 12, 112, 212 and at least one modular foam support element 30 which is movably and/or removably associated, also during the process, with the foam separation cell 12, 112, 212.

In some embodiments, a plurality of modular elements 30 are included, which are mutually associated to define a three-dimensional foam support structure.

The modular elements 30 may have an elongated, flat or curved shape, and may be mutually aligned, concentric or oblique to form a grid, or a toroidal or circular-crown shape, or any possible three-dimensional structure 28 that can be obtained by combining and intersecting modular elements 30, so as to allow the foams to flow upwards.

The support structure 28 may have foam containment and support volumes providing large additional support surfaces for the bubbles, so that they will not be supported by the underlying bubbles only and can thus form more stable and taller, or deeper, foams.

In some embodiments, the modular elements 30 combined together to form the structure 28 can form the internal structure of a foam support module 14.

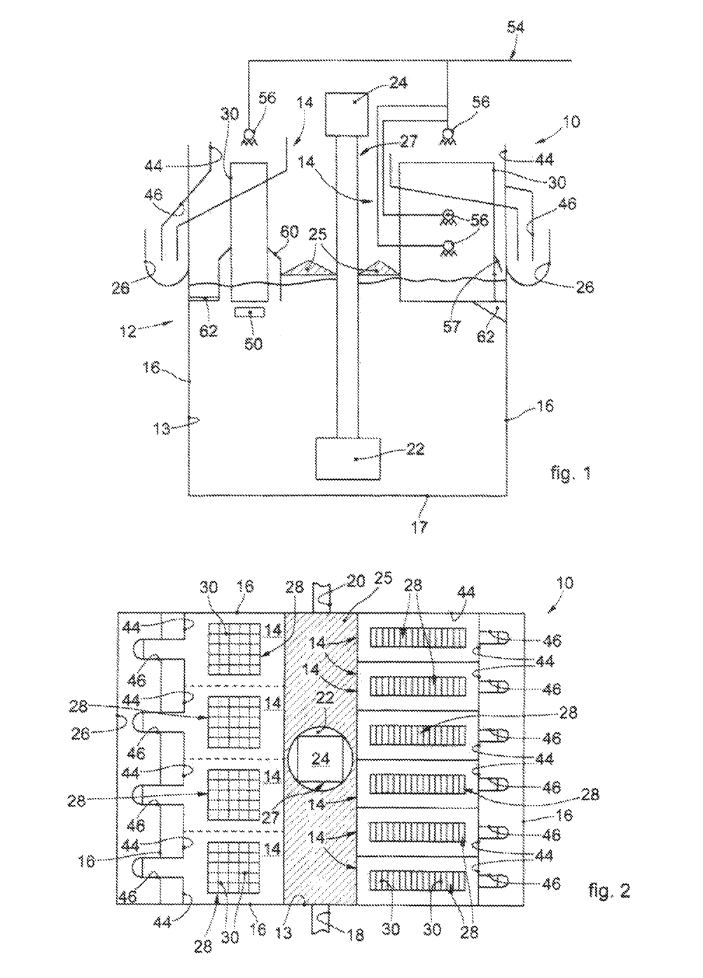

In embodiments described herein with reference to FIG. 1, a mechanical foam separation cell 12 comprises a treatment chamber 13, defined by outer side walls 16 and by a bottom wall 17, and configured to contain the pulp or liquid and to carry out the separation of the hydrophilic material from the hydrophobic material. The foam separation cell 12 comprises an opening 18 for supplying a flow of material to be separated, and an drain opening 20 for draining the effluent, i.e. the liquid containing the hydrophilic material, which is generally located near the bottom 17.

The foam separation cell 12 also includes a rotor 22 connected to and driven by a motor 24, which keeps the pulp in agitation and prevents sedimentation of the material contained therein. There may also be air supply means 27, e.g. associated with the rotation of the motor or connected to a blower or a compressor; this air is necessary for generating the bubbles to which the hydrophobic material will adhere. For example, the combined action of the rotor and stator of the impeller 22 may be used (the stator is not shown in the drawing) in order to generate small bubbles.

The mechanical separation cell 12 is also generally provided with a support structure, also referred to as bridge, 25, configured to support the assembly including the impeller 22 and the motor 24. The bridge 25 may be a frame or a support plate.

The bubbles rise towards the upper part of the foam separation cell 12 and, when they have reached a height taller than the outer walls 16, will tend to fall into suitable foam collectors 26, from which they will be discharged in order to recover the separated material concentrate.

In addition and/or as an alternative, near the edge of the side wall(s) 16 of the separation cell 12 there may be one or more ports (not shown in the drawings) for draining or letting out the foam from the cell 12 into the collectors 26.

In some embodiments, the modular elements 30 and/or the foam support modules 14 are installed in the upper part of the foam separation cells 12, and can be partly placed inside the pulp or on top of it. The modular elements 30 and/or the modules 14 may be applied to the edge of a foam separation cell 12 or associated therewith, or suspended with respect to the pulp or liquid, or floating thereon.

Advantageously, the modular elements 30 and/or the foam support modules 14 are associated with the separation cell 12 in a movable and/or removable manner Because of this, they can be moved or removed also while the cell 12 is in operation during the foam separation process of the invention.

This will make it possible to take action immediately as required: for example, in the event of a malfunction, a failure or the like, or for replacing one or more modular elements 30 or foam support modules 14, or for checking the progress of the separation process, or for taking foam samples to be examined.

As a matter of fact, when removing, raising or anyway moving one or more modular elements 30 and/or foam support modules 14, also the foam deposited thereon will be removed.

The foam thus obtained can then be analyzed separately in a laboratory or visually by an operator for the purpose of evaluating its properties (e.g. density, purity, composition, etc.) and obtaining an indication about the progress of the separation process; it will thus be possible to check whether the process is going on regularly or requires some changes in the process parameters (e.g. quantity of blown air, revolution speed of the impeller 22 for pulp agitation, time of permanence in the separator, etc.).

In some embodiments, the foam support module 14 can be hermetically or non-hermetically connected to a foam separation cell 12, 112, 212; in both cases, the foams will rise due to the wall effect increased by the inner structure 28.

In accordance with embodiments described herein with reference to FIGS. 1 and 2, the modular elements 30 and/or the foam support modules 14 can be associated with the foam separation cell 12 in such a way as to cover the whole free surface of the pulp, or only a part thereof.

For example, in the right-hand part of FIGS. 1 and 2 an exemplary solution is shown wherein six modular elements 30 and/or foam support modules 14 cover the entire free surface of the pulp (from the center towards the wall 16) and collect all the foam and the concentrate that rise towards the upper part of the foam separation cell 12; in this case, the covering is almost hermetical.

In the left-hand part of FIGS. 1 and 2 an exemplary solution is shown wherein four foam support modules 14 are so arranged as to not cover the whole free surface, but only the innermost part that is farthest from the foam collector 26. The foams can thus be discharged in the traditional manner, with particles and fibers, including rough ones, being collected in the foam collectors 26, while the innermost part is cleaned in the foam support module 14 to provide a purer concentrate. These two solutions may be used either alone or combined together or with further embodiments.

The solution illustrated in the left-hand part allows using the foam support module 14 as a “foam crowder” in traditional foam separation cells 12, 112, 212, so that deeper foams can be formed also near the outer walls 16.

The foams must not be too deep in the outermost part because this would shorten the average time of permanence in the foam separation cells 12, 112, 212, since the usable volume would be reduced, leading to reduced recovery of hydrophobic material in the foams. The modular elements 30 and/or the foam support modules 14 offer the advantage that very tall foams can be obtained while keeping unchanged the average time of permanence of the pulp or liquid in the foam separation cell 12, 112, 212. The average time may also be increased, if the level of the pulp or liquid is raised and the respective modular elements 30 and/or foam support modules 14 are so arranged as to hermetically cover the whole free surface. This may turn out to be particularly useful in existing systems of foam separation cells 12, 112, 212, which cannot provide satisfactory results because they are undersized.

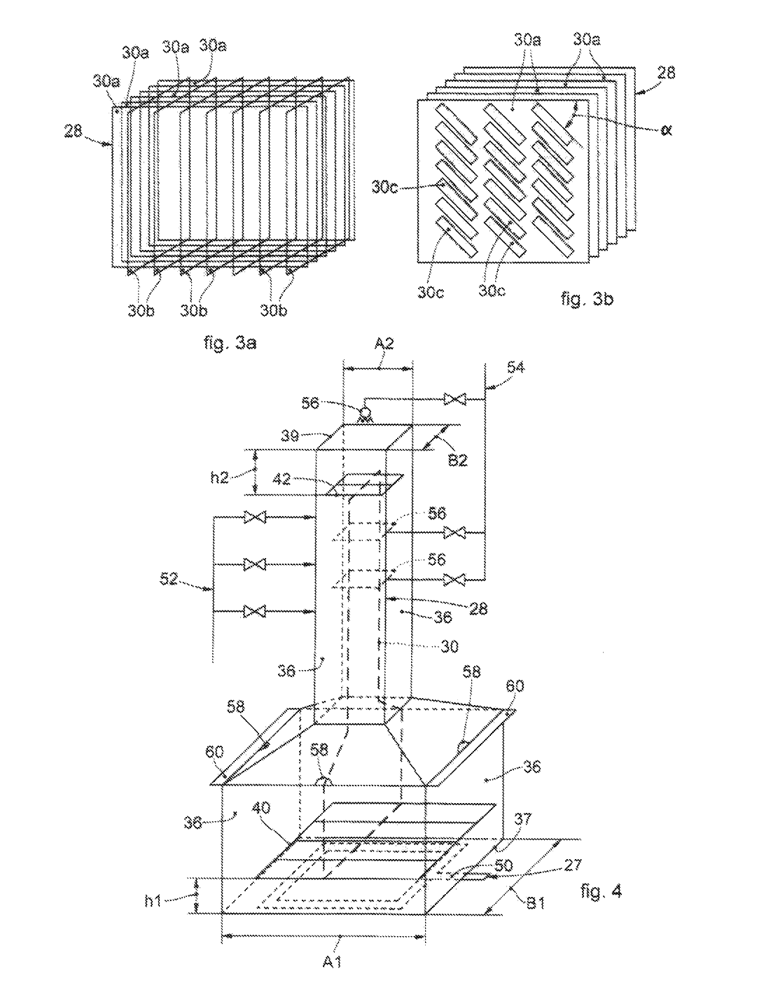

According to embodiments described herein with reference to FIG. 3a, the modular elements 30 can comprise modular-wall elements 30a, 30b arranged parallel or in transverse directions to define the structure 28, e.g. in the form of a three-dimensional grid. The modular elements 30a, 30b may be disposed in orthogonal directions or inclined relative to one another by an angle other than 90°.

The modular elements 30a, 30b may be either aligned vertically or arranged obliquely.

In some embodiments, the modular elements 30 may have flat surfaces or be provided with through holes or slots to allow the bubbles and the foams to flow in the transverse direction.

The modular elements 30a, 30b define foam passage volumes having a relatively narrow cross-section. Such sections may become clogged with solid particles or fibers contained in the pulp.

The presence of perforated modular elements 30a, 30b will allow pulp, foam and/or bubbles to flow transversally to ensure self-levelling of the pulp or liquid inside the structure 28. This means that lateral movements and higher efficiency can be obtained when a channel or passage gets clogged, by allowing its content to re-distribute itself into the adjacent passages.

According to a variant embodiment described herein with reference to FIG. 3b, the structure 28 may comprise modular elements 30a arranged parallel to one another with the interposition of linking modular elements 30c having an elongated shape and a thickness that is much smaller than the dimensions that define its surface. In some embodiments, the linking modular elements 30c may be arranged in the orthogonal direction or inclined by an angle α other than 90° with respect to the modular elements 30a.

A bubble and/or a particle moving in the vertical direction has a weight that is equal to its mass multiplied by gravitational acceleration (m×g). The inclined linking element 30c can provide the bubbles with support equal to m×g×cos α in the direction perpendicular to the surface of the linking element 30c; the particle will then have a reduced weight in the direction parallel to the surface, equal to m×g×sin α, i.e. less than or equal to m×g. The weight of the bubbles and of the particles contained therein will thus be reduced not only by the wall effect caused by the modular elements 30a, but also by the reaction exerted by the inclined linking element 30c.

In further embodiments, the structure 28 may consist of a lattice made up of a plurality of solid or hollow modular elements 30 having one prevalent dimension.

In some possible solutions, the modular wall elements 30a, 30b may be made as one piece extending from the lower part to the upper part of the internal structure 28 or along a transverse development thereof, or they may be made up of multiple modular elements 30, mutually superimposed and combined, or connected and kept spaced apart by means of further linking elements 30c, e.g. linking tie rods.

FIG. 4 is used herein as a reference to describe a foam support module 14 that comprises at least one modular element 30, in particular a plurality thereof.

The foam support module 14 may have peripheral surfaces and inner surfaces, defined by the modular elements 30 that provide additional support surfaces for the foams.

In some embodiments, the foam support module 14 may comprise side walls 36 that define an enclosure 38 which peripherally encloses the modular elements 30. The side walls 36 may be also configured to allow the foam support module 14 to be associated with the upper part of a foam separation cell 12.

The enclosure 38 may be defined by a lower edge 37 and an upper edge 39. The lower edge 37 may be immersed in the pulp or liquid, or be suspended over it, while the upper edge 39 may be immersed or protrude past the outer walls 16 of the treatment chamber 13.

When the foam support module 14 is partly inserted in the treatment chamber 13, the side walls 36 may have through holes or slots in at least their lower part on a level with the liquid to allow lateral movement thereof inside and outside the foam support module 14. In the part external to the liquid, the side walls 36 may be designed as solid walls to retain the foams and support them until they reach the upper edge 39, where they will then be removed.

In some embodiments, the side walls 36 may be made as one piece, or they may be made up of segments joined and combined together to form the enclosure 38.

In some embodiments, the enclosure 38 may have a constant or variable cross-section between the lower edge 37 and the upper edge 39. The cross-section may also vary more than once.

For example, the cross-section defined by the lower edge 37 of the foam support module 14 may have dimensions A1 and B1, whereas the section defined by the upper edge 39 may have dimensions A2 and B2 respectively equal to the dimensions A1 and B1. The dimensions A2 and B2 of the upper edge 39 can be selected as a function of the vertical velocity of the foams to be obtained. If the air flow rate through the section remains constant, the mean velocity will be inversely proportional to the area of the section.

In some embodiments, the modular elements 30 may be anchored and fixed to the side walls 36 by using suitable known fastening means. Some examples of fastening means may be welds, bolts, hooks, joints, flanges, or the like.

Preferably, said fastening means allow the modular elements 30 and/or the foam support modules 14 to be removed even during the separation process, i.e. while the separation cell 12 is in operation.

One variant embodiment may utilize a support element 40 configured to support the modular elements 30 in the desired position and fasten them to the side walls 36. The support element 40 may be located at the lower edge 37 or at a predefined distance h1 from the lower edge 37.

One variant embodiment may include an end-of-travel element 42 configured to limit the vertical movement of the modular elements 30. The end-of-travel element 42 can be located near the upper edge 39, e.g. at a distance h2 from the latter.

In some embodiments, the support element 40 and/or the end-of-travel element 42 may comprise bars, grids or other elements suitable for supporting the modular elements 30 while allowing both the liquid and the air bubbles to pass.

In some embodiments, the support element 40 and/or the end-of-travel element 42 may be removably secured to the side walls 36, so that the modular elements 30 can be quickly extracted in order to carry out cleaning and maintenance operations.

Some embodiments may include only one support element 40 and only one end-of-travel element 42 for the entire internal structure 28, or additional support elements 40 and/or limiting elements 42 may be arranged in intermediate positions between some modular elements 30.

In some embodiments, the foam support modules 14 may comprise bubble generation and/or distribution devices 50 configured to introduce additional bubbles in order to make the separation process more efficient. Bubbles will thus be introduced both into the foam separation cells 12, 112, 212, via the known generators 21, 27, and into every single foam support module 14. In this manner, a larger number of bubbles can be supplied and forced into the foam support module 14 in order to regulate the separation and recovery of the hydrophobic material.

Additional bubbles may also be generated via forced recirculation of a part of the material exiting the foam separation cells 12, 112, 212 into further foam separation cells 12, 112, 212. This solution is typical of bubble generators comprising Venturi devices or “in-line mixers”.

In some embodiments, the foam support module 14 may comprise a foam recirculation circuit 52 configured to allow recirculation of the foams collected from upstream and/or downstream foam separation cells 12, and to output the foams at different heights of the foam support module 14.

The foam support module 14 may also comprise a foam washing circuit 54 of its own, configured to wash the foams supported by the modular elements 30 in order to improve the purity thereof, i.e. in order to obtain a purer concentrate of separated material.

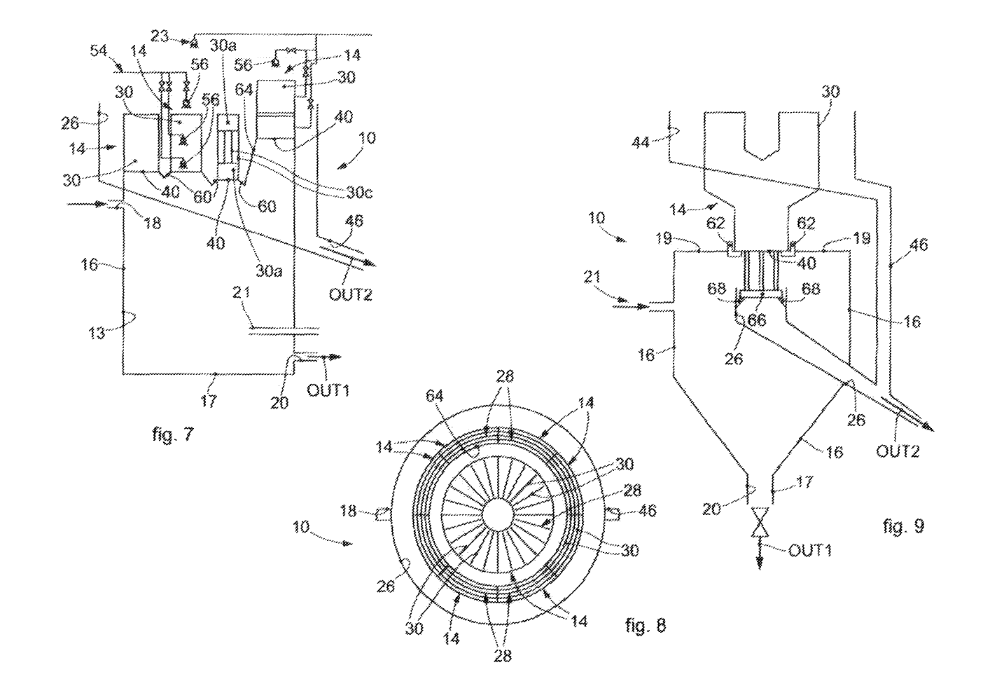

The foam washing circuit 54 may comprise one or more washing devices 56 configured to dispense water, or another suitable liquid, into the foam support modules 14, e.g. at different heights. The washing devices 56 can be used in addition to existing washing devices, like those included in column-type foam separation cells 112 (FIG. 7).

In some embodiments described herein with reference to FIG. 4, the foam support modules 14 may be equipped with handles 58, eyelets or other elements configured to allow for easy handling and installation of the foam support modules 14.

In some embodiments described herein with reference to FIG. 4, the foam support modules 14 may comprise support elements 60 configured to connect the foam support modules 14 to the foam separation cells 12, 112, 212, e.g. at and/or near the ends of the outer walls 16 of the foam separation cells 12, 112, 212, and/or suspended over the pulp or liquid. The support elements 60 may also be configured to connect together two or more foam support modules 14.

The support elements 60 may comprise lateral or angular protrusions, joints, hooks and removable fastening elements, and can be positioned at any height of the foam support module 14 for inserting it into and/or associating it with a foam separation cell 12, 112, 212 and/or a further foam support module 14, and/or the support bridge 25, and for holding it in the desired position.

The support elements 60 may be directly connected to the walls 16 or to the bridge 25, or they may be associated with and/or connected to suitable support structures 62 fastened inside the treatment chamber 13 of the foam separation cells 12, 112, 212. The support structures 62 may be configured to support the single modular elements 30 and/or the foam support modules 14.

In some variant embodiments, the modular elements 30 and/or the foam support module 14 can be constrained to the foam separation cell 12, 112, 212, so that they can move freely in the vertical direction, e.g. through the use of floats. With this solution, the height of the foams can be kept constant in the structure 28 independently of the level of the liquid in the foam separation cell 12, 112, 212. There may be end-of-travel elements configured to limit the downward movement and to prevent the modular elements 30 and/or the foam support module 14 from damaging parts of the foam separation cell 12, 112, 212, e.g. the impeller, or anti-wear coatings.

In some embodiments that may be combined with all of the embodiments described herein, the foam support modules can be equipped, on one or more side walls 36 of the enclosure 38, with side doors 57 configured to allow the concentrate to be removed from the foam support module 14, should the latter become clogged and prevent the foams and the concentrate from correctly travelling towards the upper edge 39. It will thus be possible, in the event that a foam support module 14 becomes obstructed, to continue using the separation apparatus 10 as a traditional foam separation cell 12, 112, 212.

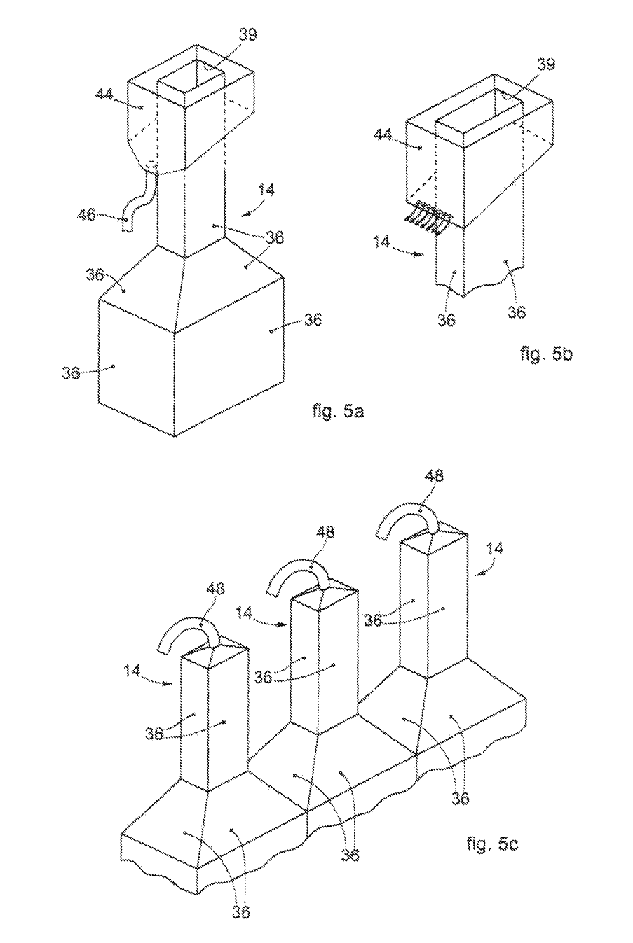

FIGS. 5a-5c are useful to describe different methods for collecting the foams at the upper edge 39 of the foam support module 14.

The foams can be collected, e.g. by overflow, into suitable collectors 44, which are then evacuated via a collection tube 46 (FIG. 5a) or through a drain opening from the collector 44 into an underlying container, collector or tank (FIG. 5b).

In some possible variants, the foams can be collected and discharged directly through one or more collection tubes 48 arranged on top of the foam support modules 14 (FIG. 5c).

The collection tubes 46 and/or 48 can be connected to respective foam collectors 26 of the foam separation cells 12, 112, 212.

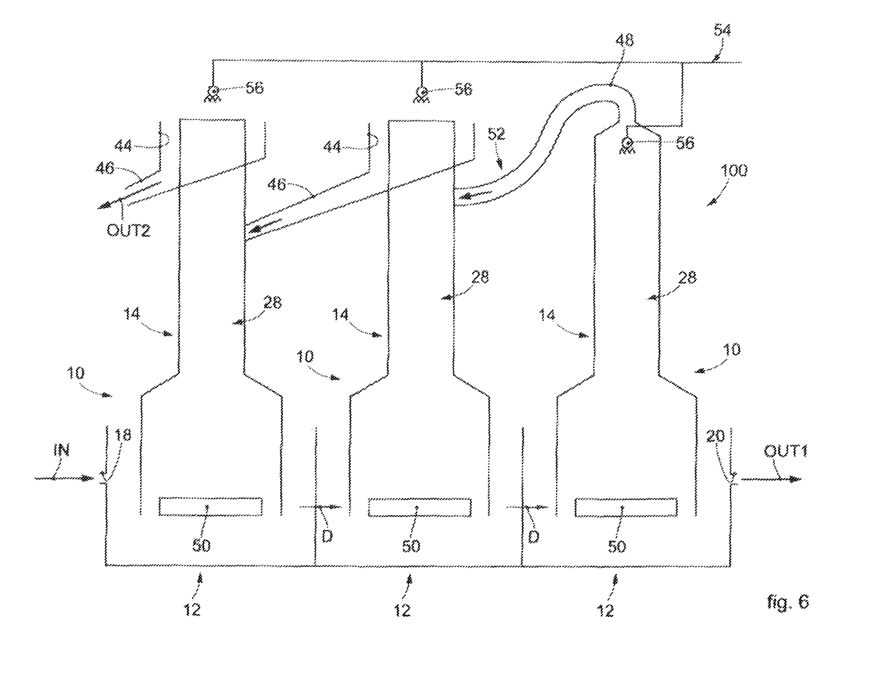

FIG. 6 is useful to describe an exemplary embodiment of a bank 100 comprising a plurality of separation apparatuses 10, each one comprising a foam separation cell 12, e.g. a mechanical one (some parts of which, e.g. the impeller, are not shown for clarity), and a foam support module 14, connected together to allow the pulp and the hydrophobic material to flow between them.

It has been experimentally demonstrated that the efficiency of the process increases when the hydrophobic material recovered from a bank of foam separation cells 12, 112, 212 is fed directly into the foams of the preceding foam separation cells 12, 112, 212 in order to recirculate the concentrate collected therein.

The technical problem encountered in prior-art industrial plants lies in the fact that it is impossible to attain a foam depth that will allow recirculating the collected concentrate directly into the foams, let alone subsequently rejecting the hydrophilic material still present therein.

The foam support module 14 allows the formation of deep foams through the wall effect and then feeding the hydrophobic material directly into the foams as shown in FIG. 6, which shows by way of example how the concentrate is recirculated directly from one foam support module 14 into another between a foam separation cell 12 and the preceding one via a foam recirculation circuit 52.

For example, the pulp is supplied into the first foam separation cell 12 on the left (arrow IN), wherein a first separation occurs between foams and pulp; the foams retaining the hydrophobic material will then go up, while the pulp containing the hydrophilic material will be delivered into the next foam separation cell 12 (arrow D) to be subjected to further separation processes. Finally, when the last foam separation cell 12 of a series or bank of the system 100 is reached, the effluent containing almost exclusively hydrophilic material will be definitively evacuated (arrow OUT1).

Instead, the foams containing the separated hydrophobic material will follow an inverse path, since they will be recovered from the top of the last foam separation cell 12 through the collection tube 48 and recirculated into the foams collected in the foam support module 14 of the preceding foam separation cell via the foam recirculation circuit 52, and so on until they return into the foam support module 14 of the first foam separation cell 12, from which the separated concentrate will be recovered (arrow OUT2).

Total, or preferably partial, recirculation of the material floated in the foam support modules 14 may also be effected differently by using a pump or an “air lift”. Also, it can be chosen whether to recirculate only the concentrate collected in the modules 14 or the entire amount of (floated) foams produced.

It is clear that this type of supply can also occur between different banks 100, not necessarily between foam separation cells 12 of the same bank 100.

The foam separation cells 12, 112, 212 are typically connected in banks 100 in a foam separation plant, and can act as foam separation cells 12, 112, 212 of a “rougher”, “scavenger” or “cleaner” bank. For example, they may be configured to carry out a first rough separation between hydrophilic and hydrophobic materials, or subsequent separation steps for recovering additional hydrophobic material from the effluent, and/or for eliminating any hydrophilic material that may still be present in the concentrate obtained from the preceding foam separation cells 12, 112, 212.

In some variant embodiments described herein with reference to FIG. 7, an apparatus 10 comprises a column-type foam separation cell 112 comprising a treatment chamber 13 defined by outer walls 16 and a bottom wall 17, and configured to retain the pulp and carry out the separation of the hydrophilic material from the hydrophobic material. The column-type foam separation cell 112 comprises an intake opening 18 for taking in the pulp or liquid and a drain opening 20 for draining the effluent.

Generally, the column-type foam separation cell 112 comprises also an air bubble generator 21, configured to generate bubbles of the desired size inside the treatment chamber 13.

Column-type foam separation cells 112 further comprise washing devices 23 that deliver water in countercurrent against the foams to promote the sliding of any hydrophilic material retained by the air bubbles towards the bottom 17.

In some embodiments described herein with reference to FIG. 7, the foam support modules 14 can be so arranged as to cover, whether totally or partially, the top surface of the foam separation cell 112. The foam support modules 14 may be either inserted into the treatment chamber 13 (on the left in FIG. 7) or secured to the upper part of the outer walls 16 (on the right in FIG. 7), so that they will still be in fluidic connection with the treatment chamber 13. Between adjacent foam support modules 14, foam passage channels 64 may be provided to convey the foams towards the collectors 44 and/or towards additional collectors.

When the foam support modules 14 protrude upwards from the treatment chamber 13, the total volume of the apparatus 10 will be increased, thus improving the performance thereof. By way of example, assuming that 3 m of foams need to be generated in a column-type foam separation cell 112 that is 6.5 m tall, which generally works with foams approx. 0.5 m tall, the usable volume of liquid in the foam separation cell 112 will be reduced to just 3 m, i.e. halved. If the foam support module 14 protrudes from the foam separation cell 112, 2.5 m of foams can be generated outside the foam separation cell 112 while keeping constant the average time of permanence of the pulp or liquid, thereby providing foams six times taller.

Production of deeper foams is also promoted when the foam support modules 14 are immersed underneath the foams. Moreover, the modules 14 can dampen turbulences and “waves” that may be generated if too much air is blown. Thanks to wave dampening, the modules 14 allow operation with very shallow foams, because no pulp or liquid will be discharged directly into the concentrate.

FIG. 8 is useful to describe a schematic top view of an apparatus 10 for particle separation that comprises a column-type foam separation cell 112, the surface of which is almost entirely covered with a plurality of foam support modules 14, the cross-section of which is in this case a circular crown sector. According to this solution, the foam support modules 14 have a circular-sector cross-section and are disposed in connection with one another to form circular crowns.

In some variant embodiments described herein with reference to FIG. 9, an apparatus 10 comprises a centrifugal foam separation cell 212 comprising a treatment chamber 13 defined by outer side walls 16 and top walls 19, and configured to separate the hydrophilic material from the hydrophobic material. The pulp or liquid is supplied through the opening 18, and the effluent is drained through the drain opening 20. The treatment chamber 13 may have a cylindrical shape in its upper part and a truncated conical shape tapering in its lower part towards the drain opening 20.

The bubbles will rise towards the upper part of the foam separation cell 212 and, when they reach a certain height inside the treatment chamber 13, they will tend to fall back down into suitable foam collectors 26 arranged inside the treatment chamber 13.

In this solution, one or more modular elements 30 and/or foam support modules 14 can be secured to a top wall 19 of the foam separation cell 212, e.g. by connecting the support element 40 to a support structure 62.

A closing element 66, configured to close the mouth of the foam collector 26, may also be connected to the support structure 62 and/or to the support element 40 in order to force all the bubbles to go up towards the foam support module 14.

The closing element 66 can be configured to switch from a mouth closing position to a mouth opening position and, in the closing position, it may rest on abutment elements 68 that are present in the foam collector 26.

In light of the above description, it is possible to understand that the peculiarity of the invention of using one or more modular elements 30 and/or foam support modules 14 that are movable and/or removable during the foam separation process allows them to be extracted from the separation cell 12, 112, 212 also when the latter is in operation.

On the one hand, this allows the execution of maintenance, cleaning and replacement work on the modular elements 30 or modules 14; on the other hand, it also allows taking samples of the foam deposited on such modules.

In fact, the foam retained by the modular elements 30 or by the modules 14 can be picked up when they have been raised (by floats or by an operator) or removed from the cell 12, 112, 212; such foam can then be analyzed (e.g. in a laboratory or visually by an operator) to obtain useful information about its composition, purity, etc., which information will allow monitoring the progress of the separation process and making any necessary changes, should any differences be detected with respect to the desired conditions.

In this respect, it must be pointed out that it is important for the invention that the modular elements 30 and/or the foam support modules 14 are accessible from outside the separation cell 12, 112, 212; preferably, they can be manipulated from above by an operator or by a lifting device (crane, travelling crane, or the like): it is for this reason that the separation cell 12 is preferably open at the top.

It is clear that the apparatus and the process for particle separation described herein may be subject to changes and/or additions of parts without departing from the scope of the present invention.

It is also clear that, although the present invention has been described herein with reference to some specific examples, a man skilled in the art will certainly conceive many other equivalent embodiments of an apparatus and a process for particle separation having the features set out in the claims, and hence still falling within the protection scope defined therein.

### INDEX

10 Apparatus for foam separation
12 Mechanical foam separation cell
13 Treatment chamber
14 Foam support module
16 Outer walls
17 Bottom wall
18 Supply opening
19 Upper outer walls
20 Drain opening
21 Air bubble generator
22 Impeller
23 Washing devices
24 Motor
25 Bridge
26 Foam collectors
27 Air introduction means
28 Internal structure
30 Modular elements
30a Modular walls
30b Modular walls
30c Linking modular elements
36 Side walls
37 Lower edge
38 Enclosure
39 Upper edge
40 Support element
42 End-of-travel element
44 Collectors
46 Collection tube
48 Tubes
50 Bubble generators
52 Foam recirculation circuit
54 Foam washing circuit
56 Washing device
57 Doors
58 Handles
60 Support elements
62 Support structures
64 Foam passage channels
112 Column-type foam separation cell
212 Centrifugal foam separation cell
A1 Dimension
A2 Dimension
B1 Dimension
B2 Dimension
D Arrow
h1 Distance
h2 Distance
α Angle
IN Pulp inlet
OUT1 Effluent outlet
OUT2 Concentrate outlet

1-15. (canceled)

16. An apparatus for foam separation, comprising:
a foam separation cell provided with a treatment chamber inside of which a flow of liquid containing material to be separated can be introduced;
and one or more devices for introducing and/or generating air bubbles, for carrying out the foam separation between hydrophobic material and hydrophilic material,
wherein said apparatus comprises at least one modular foam support element movably and/or removably associated with said foam separation cell during the separation process.

17. The apparatus according to claim 16, further comprising: a plurality of modular elements associated with one another to form an internal structure of a foam support module configured to provide additional support surfaces for the foams, said foam support module being movable and/or removable during the separation process.

18. The apparatus according to claim 16, wherein said modular elements have, in a front view, an oval, circular, square, polygonal, regular or irregular shape, or any other possible shape, and in that said modular elements have a flat and/or curved shape.

19. The apparatus according to claim 16, wherein said modular elements have a constant or variable section along a longitudinal and/or transverse development.

20. The apparatus according to claim 16, wherein said structure is a lattice or a grid, or a structure having a toroidal or circular-crown shape, or a three-dimensional structure having any shape, configured to create passage volumes and additional support surfaces for supporting the foams and promoting the upward flow thereof.

21. The apparatus according to claim 16, wherein said at least one modular element and/or foam support module comprise a bubble generation and/or introduction device configured to generate and/or introduce air bubbles in order to increase the overall flow of bubbles and promote the growth and stability of the foams in the apparatus.

22. The apparatus according to claim 16, wherein said at least one modular element and/or foam support module comprise a foam recirculation circuit configured to allow recirculation of concentrate in the foams.

23. The apparatus according to claim 16, wherein said at least one modular element and/or foam support module comprise one or more washing devices configured to deliver water and/or liquid at different heights inside said foam support module.

24. The apparatus according to claim 16, wherein said modular elements and/or said foam support modules are arranged in such a way as to cover the whole free surface of the liquid in said foam separation cell, or only a part thereof.

25. The apparatus according to claim 16, wherein said modular elements and/or said foam support modules are installed in the upper part of the foam separation cells and can be partly placed within the pulp or liquid, or on top of it.

26. The apparatus according to claim 16, wherein the modular elements and/or the modules can be applied to the edge of a foam separation cell, or otherwise associated therewith, or suspended in the pulp or liquid, or left to float on the latter.

27. A process for foam separation in a foam separation cell, providing for:
introducing a flow containing the material to be separated into a treatment chamber;
generating and/or introducing air bubbles into said treatment chamber;
separating, from the hydrophilic material, the hydrophobic material that adheres to the bubbles and is transported towards the free surface of the liquid in said treatment chamber; and
producing very deep foams, while supporting them by means of at least one modular element and/or one foam support module associated with said foam separation cell in an apparatus comprising:
a foam separation cell provided with a treatment chamber inside of which a flow of liquid containing material to be separated can be introduced;
and one or more devices for introducing and/or generating air bubbles, for carrying out the foam separation between hydrophobic material and hydrophilic material,
wherein said apparatus comprises at least one modular foam support element movably and/or removably associated with said foam separation cell during the separation process.

28. The process according to claim 27, comprising a step of removing at least one modular element and/or one foam support module from the separation cell in order to extract a foam sample to be analyzed during the process.

29. The process according to claim 28, wherein one or more operating parameters of the separation cell are controlled as a function of the properties of the analyzed foam sample.

30. A device for controlling the process according to claim 27, comprising a modular element and/or a foam support module removably associated with said foam separation cell during the operation of the separation cell.
